(19) United States
(12) Patent Application Publication
(10) Pub. No.: US 2021/0231048 A1
(43) Pub. Date: Jul. 29, 2021

(54) DOUBLE ACTING PISTON ENGINES

(71) Applicant: Georg Deeke, Oxford (GB)

(72) Inventor: Georg Deeke, Oxford (GB)

(21) Appl. No.: 15/733,954

(22) PCT Filed: May 30, 2019
(86) PCT No.: PCT/GB2019/051475

§ 371 Date: Dec. 1, 2020

(30) Foreign Application Priority Data
Jun. 2, 2018 (GB) 1809068.8

(51) Int. Cl. F02B 75/00; F01M 11/02; F01M 1/06; F01M 1/16; F02B 75/02; F16J 15/447; F16J 15/3288; F16J 15/3284; F01L 1/06; F01L 3/08

(52) U.S. Cl. CPC F02B 75/002; F01M 11/02; F01M 1/06; F01M 1/16; F02B 75/02; F16J 15/447; F02B 2075/027; F16J 15/3284; F01L 1/06; F01L 3/08; F01M 2011/022; F01M 2001/066; F16J 15/3288

(57) ABSTRACT

A linear reciprocating piston engine including a cylinder; a piston located within the cylinder, the piston separating upper and lower combustion chambers of the cylinder; a separation plate disposed across a lower end of the cylinder to seal the lower combustion chamber; and a joint disposed in the separation plate. The joint includes a bore through which a connecting rod extends to connect the piston to a crankshaft. Movement of the piston along a longitudinal axis of the cylinder causes the connecting rod to rotate the crankshaft, said rotation of the crankshaft causing both transverse and angular movement of the connecting rod relative to the longitudinal axis of the cylinder. The angular movement of the connecting rod causes a corresponding angular movement of the joint. The joint includes a curved outer surface and an inner seal disposed between the bore and the connecting rod.

### FIELD

This invention relates to double acting internal combustion engines operating on a four stroke cycle.

### BACKGROUND OF THE INVENTION

Double acting internal combustion engines are taught in WO0250410. This document describes a linear reciprocating piston engine having upper and lower combustion chambers either side of the piston. The lower chamber is sealed by a separation plate that is configured to accommodate the throw of the connecting rod as it moves about the crankshaft. Although such engines offer good power to weight, their reliable realisation is restricted by two major technical obstacles: The first of these is the difficulty in providing an effective seal of the lower combustion chamber; while the second is the problem of providing adequate lubrication of the piston.

The present invention seeks to provide an improved double acting internal combustion engine.

### STATEMENTS OF INVENTION

According to the invention, there is provided a linear reciprocating piston engine comprising:
a cylinder;
a piston located within the cylinder, the piston separating upper and lower combustion chambers of the cylinder;
a separation plate disposed across a lower end of the cylinder to seal the lower combustion chamber;
a joint disposed in the separation plate, the joint comprising a bore through which a connecting rod extends to connect the piston to a crankshaft,
wherein movement of the piston along a longitudinal axis of the cylinder causes the connecting rod to rotate the crankshaft, said rotation of the crankshaft causing both transverse and angular movement of the connecting rod relative to the longitudinal axis of the cylinder, the angular movement of the connecting rod causing a corresponding angular movement of the joint; wherein the separation plate is configured to slide across the lower end of the cylinder to accommodate the transverse movement of the connecting rod; and wherein the joint comprises a curved outer surface configured to ensure contact with an outer seal disposed between the separation plate and the joint during angular movement of the joint and the connecting rod;
the joint further comprising an inner seal disposed between the bore and the connecting rod;
wherein the outer and inner seals are selected from any of:
   a split ring compression seal;
   a split ring expansion seal;
   a gapless expansion seal;
   a gapless compression seal;
   a labyrinth seal; and
   a brush seal.

The inner seal may comprise at least two split ring seals spaced along the bore of the joint.

The or each inner seal may be located in a respective groove in the bore of the joint.

The inner seal may be a labyrinth seal comprising a castellated inner edge.

The curved outer surface of the joint may be a spherical outer surface.

The lower end of the cylinder may be provided with a separation plate seal between the lower combustion chamber and the separation plate.

The engine may further comprise a bottom end component housing the crankshaft, the bottom end component being arranged to hold the separation plate against the lower end of the cylinder.

A seal may be disposed between the bottom end component and the separation plate.

Also according to the invention there is provided a linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a connecting rod extending through a sealed opening of the separation plate and connecting the piston to a crankshaft;
wherein movement of the piston along a longitudinal axis of the cylinder causes the connecting rod to turn the crankshaft, the separation plate being configured to accommodate movement of the connecting rod in a transverse direction, relative to the longitudinal axis of the cylinder;
and wherein the separation plate is curved to project into the cylinder and distribute combustion forces to edges of the separation plate.

Also according to the invention there is provided a linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a connecting rod extending through a sealed opening of the separation plate and connecting the piston to a crankshaft;
wherein the piston comprises oil outlets disposed in a cylindrical outer face of the cylinder, said oil outlets communicating with an oil gallery extending through the connecting rod; and wherein each oil outlet is configured to regulate the oil film thickness on the cylinder wall.

Each oil outlet may comprise a valve.

Each valve may comprise a ball bearing located in a countersunk mouth of a respective oil outlet.

The piston may comprise upper and lower oil control rings, the oil outlets being located between the oil control rings.

The piston may further comprise oil scavenging ports in the cylindrical wall, the oil scavenging ports being configured to absorb excess oil from the cylinder wall.

Also according to the invention there is provided a linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a connecting rod extending through a sealed opening of the separation plate and connecting the piston to a crankshaft;
wherein the separation plate is located in a guide configured to allow the separation plate to move to accommodate transverse movement of the connecting rod, relative to a longitudinal axis of the cylinder, the guide comprising internal oil galleries configured to provide pressurised oil to support the separation plate on a hydrostatic oil bed.

The lower end of the cylinder may be provided with a separation plate seal between the lower combustion chamber and the separation plate, the seal being configured to restrict oil transfer from the guide into the lower combustion chamber.

### BRIEF DESCRIPTION OF THE FIGURES

FIG. 1 is a schematic drawing of a cylinder a double acting engine comprising a separation plate;

FIG. 2 is a partial view of an optional feature of the separation plate of the engine, as shown in detail in FIG. 2A;

FIG. 3 is a schematic drawing of a cylinder a double acting engine comprising a separation plate of an alternate design;

FIG. 4 is a detail view of a joint of the separation plate of the engine of FIG. 3;

FIG. 5 is a detail view of an optional sealing arrangement for the joint of FIG. 4;

FIG. 6 is a schematic drawing of a cylinder a double acting engine comprising a separation plate of an alternate design;

FIG. 7 is a detail view of an optional sealing arrangement for a separation plate;

FIG. 8 is a detail view of an optional sealing arrangement for a separation plate;

FIG. 9 is a schematic drawing of a cylinder a double acting engine of an alternative design;

FIG. 10 is a schematic view in the direction of arrow A of the engine of FIG. 8;

FIG. 11 is a schematic view of a piston lubricating system for a double acting engine of any of the designs of FIGS. 1 to 10;

FIG. 12 is a schematic representation of the operational cycle of the cylinder shown in any one of FIGS. 1 to 11; and

FIG. 13 is a schematic representation of an alternative operational cycle of the cylinder shown in any one of FIGS. 1 to 11.

### DETAILED DESCRIPTION OF THE INVENTION

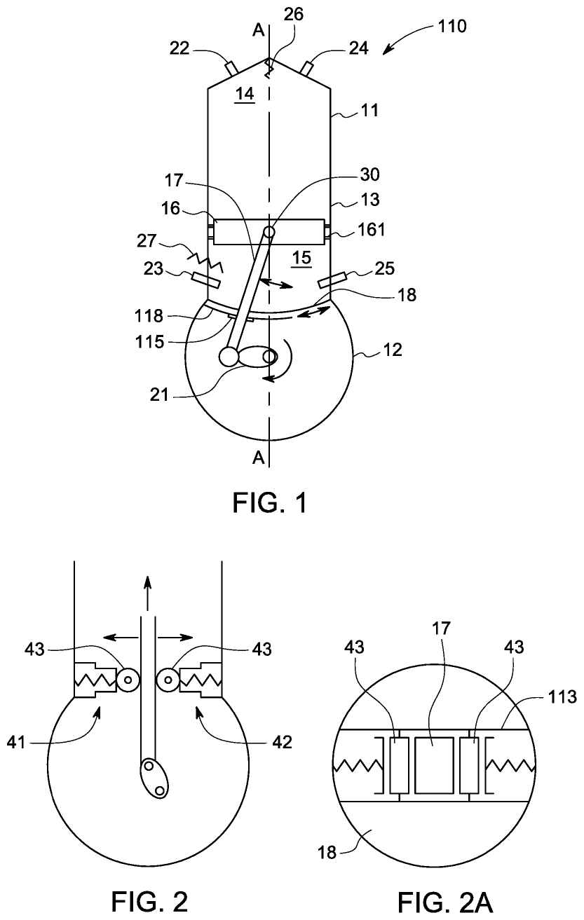

With reference to FIG. 1 there is shown an internal combustion engine 110 according to the present invention and which is a four stroke engine operable on all conventional fuels e. g petrol, alcohol, fuel oil, hyrocarbon gases, hydrogen etc.

The engine 110 comprises a cylinder block 11 mounted on a sump 12. For the sake of convenience only a single cylinder 13 is shown but the block 11 could house any number of cylinders as is desired for a particular engine configuration.

The cylinder 13 is divided into upper and lower combustion chambers 14 & 15 by a reciprocable piston 16. Piston rings 161 ensure a gas tight seal between the piston 16 and the cylinder wall 13.

The piston 16 is a double acting piston and is directly connected to a connecting rod 17 which sealingly passes through a separation plate 18 which separates the lower chamber 15 from the sump 12.

The term“double acting” means that a power stroke for the engine can be performed in either direction of movement of the piston 16.

The piston 16 is connected via a pin 30 to the connecting rod 17 which in turn is connected directly to the crank shaft 21 in the conventional manner. The separation plate 18 is configured to accommodate lateral movement of the connecting rod 17 as it moves around the crank shaft's axis. The term “lateral movement” means movement perpendicular to a longitudinal axis of the cylinder 13, A-A. The term “vertical movement” means movement in a direction parallel to the longitudinal axis A-A of the cylinder 13.

In the example of the engine no illustrated by FIG. 1, the separation plate 18 comprises an aperture 113 to accommodate lateral movement of the rod 17. The aperture is closed by a slide portion 118 with a sealed opening provided around the connecting rod. The slide portion 118 extends over the aperture 113 and slides across the separation plate 18 with the lateral motion of the crankshaft 21. The rod 17 will also move vertically in the slide portion 118 and is sealed therein by seals 115 to accommodate such movement.

A different sealing arrangement is shown in FIGS. 2 and 2A in which a pair of spring loaded seals 41, 42 are located in the aperture 113 in separation plate 18. The connecting rod 17 may bear against the seals, or may contact bearing guides 43 mounted against the seals 41 & 42 respectively. The seals 41, 42 reciprocate in the aperture 113 to seal around the moving connecting rod.

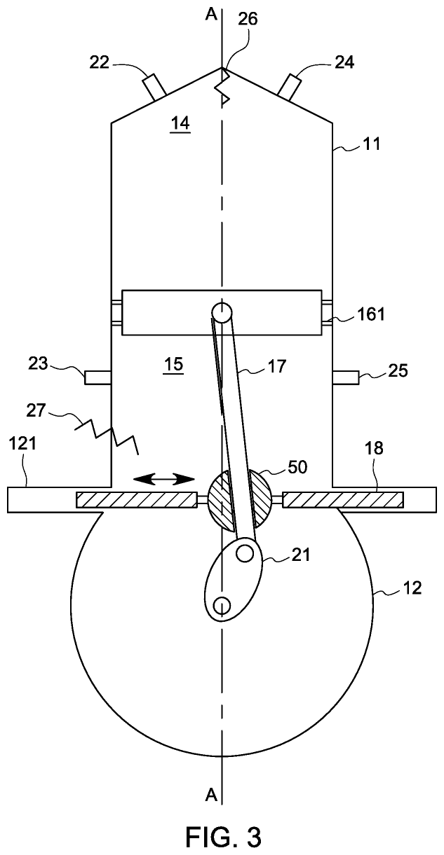

In another example of the engine illustrated by FIG. 3, the separation plate 18 is configured to move laterally. The separation plate 18 is located in a guide 121 disposed between the cylinder block 11 and the sump 12, or machined into one or the other. The length of the guide 121 transverse to the axis A-A of the cylinder 13 is greater than corresponding dimension of the separation plate 18 so that it is free to move laterally within the guide 121.

As the connecting rod 17 moves around the crank shaft's axis, the angle of inclination of the connecting rod 17 relative to the separation plate 18 changes. This changing angle is accommodated by a sealing joint 50. The sealing joint 50 is provided either directly in the separation plate 18 or in a slide portion 118, like that shown in FIG. 1.

Alternatively, the separation plate 18 may be downwardly domed—like the separation plate of FIG. 1—so that the connecting rod 17 remains perpendicular to a tangent of the domed separation plate throughout its movement of the crankshaft 21, thus negating the need for a joint. By “downwardly domed”, it is meant that the separation plate 18 projects away from the cylinder 13 and into the sump 12.

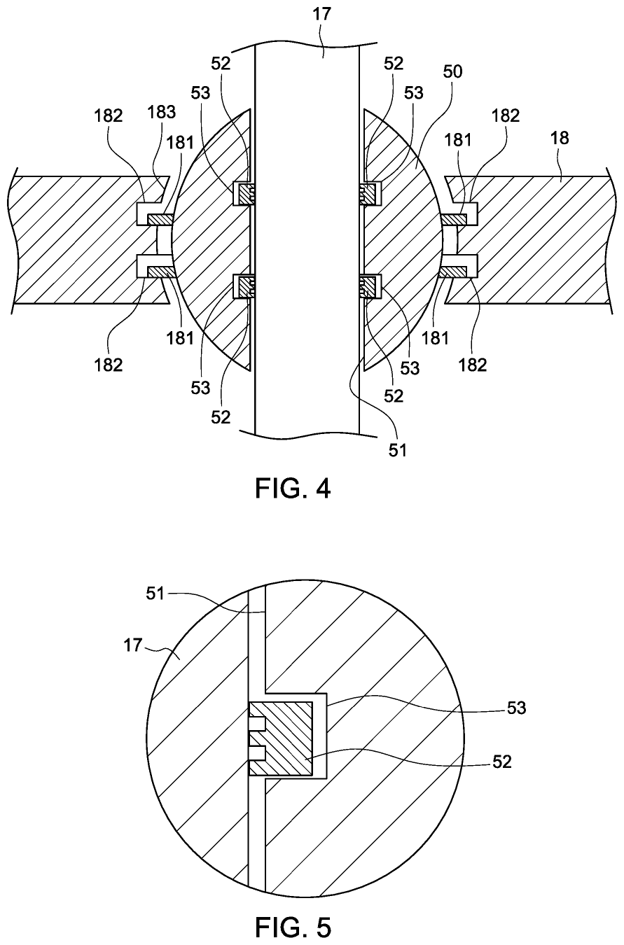

The joint 50 is located in an opening 183 of the separation plate or slide portion and comprises a bore 51 through which the connecting rod 17 extends and a curved outer surface to allow rotation of the joint 50 within the opening 183. Preferably the joint 50 comprises a spherical outer surface to accommodate slight rotation in other axes that might result from manufacturing tolerances. The joint 50 is retained by a curved inner edge of the separation plate 18 opening 183, which is shaped to prevent the joint 50 moving in a vertical direction, as illustrated in FIG. 4.

Referring still to FIG. 4, two seals are provided: An outer seal 181, disposed between the outer surface of the joint 50 and the separation plate, or slide portion; and an inner seal 52, disposed between the connecting rod 17 and the bore 51. Both seals 181, 52 have to accommodate movement of underlying surfaces. The inner seal 52 must accommodate the connecting rod 17 as it moves through the bore 51; while the outer seal 181 must accommodate rotation of the joint 50 and the associated relative movement of the outer surface and the separation plate 18 or sliding portion 118. Lubrication of the joint 50 may be effected by natural dispersion of oil during rotation of the crankshaft 21 as oil is picked up from the sump 12 and thrown against the separation plate 18, or, alternatively, oil may be sprayed from a nozzle (not shown) provided in the sump 12.

The inner and outer seals 52, 181 are split ring compression seals. In the illustrated example, the inner seal 52 comprises two split ring compression seals 52 spaced apart along the length of the bore 51, each being located in a corresponding groove 53 in the bore wall. The split nature of the seals allows them to decrease in diameter under compression to provide a seal about their inner edge against the connecting rod 17. During operation of the engine 110, when combustion occurs in the lower combustion chamber 15, combustion gasses expand into the bore 51 and grooves 53, compressing each seal 52 against the connecting rod 17 and simultaneously pushing each seal 52 onto a seat of the corresponding groove 53. This cuts off the bore 51 from fluid communication to prevent combustion gases from escaping into the sump 12. The provision of two split ring compression seals 52 ensures that the split parts of each seal 52 can be offset to further prevent the escape of gasses during combustion. However, it shall be appreciated that it is equally feasible to use gapless compression seals, in which case only a single compression seal 52 is required. Gapless compression seals may comprise a sleeve which extends over the split portion of the seal or be arranged so as to have overlapping free ends.

The outer seal 181 also comprises split ring compression seals 181, of which there are preferably two. Each seal 181 is located in a groove 182 provided about the inner edge of the opening 183. During operation of the engine 110, when combustion occurs in the lower combustion chamber 15, combustion gasses expand into the opening 183 and grooves 53, compressing each seal 181 against the outer surface of the joint 50 and simultaneously pushing each seal 181 onto a seat of the corresponding groove 182. This cuts off the opening 183 from fluid communication to prevent combustion gases from escaping into the sump 12. As with the inner seal 52, it is possible to use a gapless compression seal, in which case only a single split ring compression seal 183 is required.

In an alternative example, the outer and inner compression seals are replaced with outer and inner labyrinth seals. An example labyrinth seal is shown in FIG. 5, located in a groove 53 of the bore 51. Each labyrinth seal comprises a castellated inner edge, the castellations being arranged in the axial direction of the seal to make a tortuous path for escaping combustion gasses. In the illustrated example, a castellated inner edge of an inner seal 53 is shown in abutting relation with the connecting rod 17. Where a labyrinth seal is used for the outer seal 181, the castellated surface will be arranged in abutting relation with the outer surface of the joint 50.

In another alternative example, the outer and inner compression seals are replaced with outer and inner brush seals (not shown). Each brush seal comprises thousands of fine wires that extend from a supporting ring. The densely packed arrangement of these wires forms a barrier to escaping combustion gases whilst accommodating excursions, thermal movements of misalignments of the underlying surfaces that would otherwise reduce the efficiency of a labyrinth seal.

Compression seals, brush seals or labyrinth seals are ideally suited for dealing with the combustion forces experienced during operation of the engine. It is also possible to use split ring expansion seals where the seals are located in grooves of the other of the respective components: For example, the outer seal 181 is located in a groove in the outer surface of the joint and expands under the influence of combustion gases to seal against the inner edge of the opening 183.

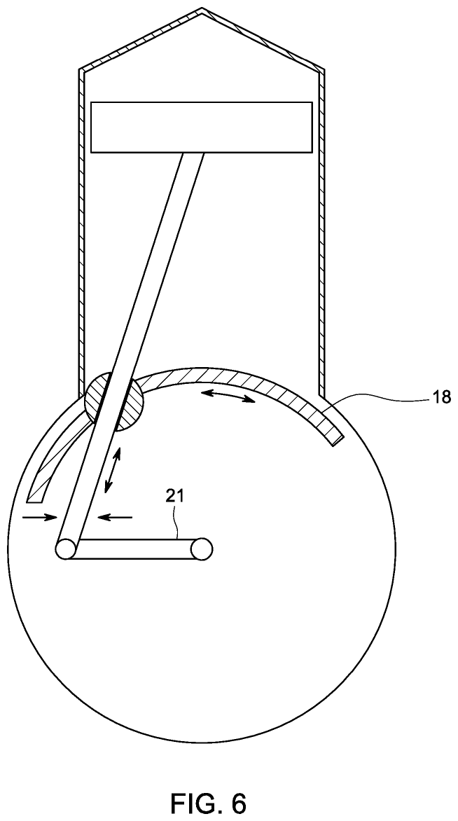

In another example of the engine, shown in FIG. 6, the separation plate is upwardly curved—for example upwardly domed—by which it is meant that the separation plate 18 partially projects into the cylinder 13. The upwardly domed shape of the plate redistributes the force to the edges of the plate and lowers the bending moment, thereby increasing longevity by decreasing the stress cycle intensity.

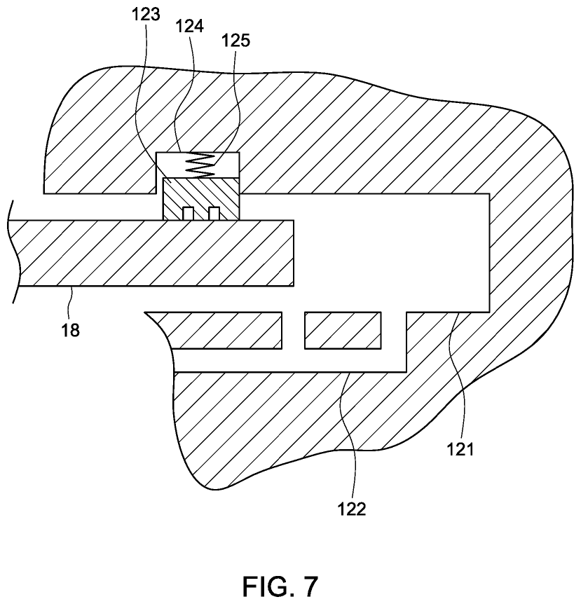

The separation plates 18 of the examples of FIGS. 3 to 6 are supported in their guide 121 by a hydrostatic oil bed. Drilled oil galleries 122 that communicate with the guide 121 allow oil to well up into the space between the separation plate 18 and the guide walls, as shown in FIG. 7. Oil pressure is maintained by an oil pump (not shown) in the conventional manner. The hydrostatic oil bed provides lubrication and protects the separation plate 18 and guide walls from premature wear by separating the two components by a film of pressurised oil.

A seal 123 is provided between the separation plate and the guide 121 in which it is located to prevent combustion gasses escaping around the edges of the separation plate 18 and into the sump 12. The seal 123 provides the further advantage of restricting oil transfer from the guide 121 into the lower combustion chamber 15. As illustrated, a channel 124 in a wall of the guide 121 is provided to retain the seal 123. The channel 124 is located inward of edges of the separation plate 18 so that the seal 123 remains in contact with the separation plate 18 as it moves laterally with the throw of crankshaft 21. The illustrated seal 123 is a labyrinth seal having a castellated surface in contact with the separation plate 18 to create a tortuous path for combustion gasses; although it shall be appreciated that any conventional sealing method may be used, including a brush seal. Preferably the seal is located on an upper surface of the separation plate 18, by which it is meant that the surface facing the lower combustion chamber 15. A spring 125 may be provided to maintain the seal 123 in contact with the separation plate 18.

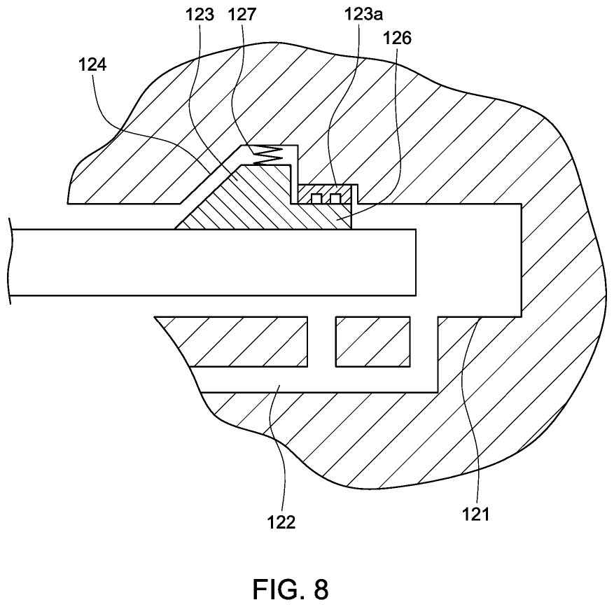

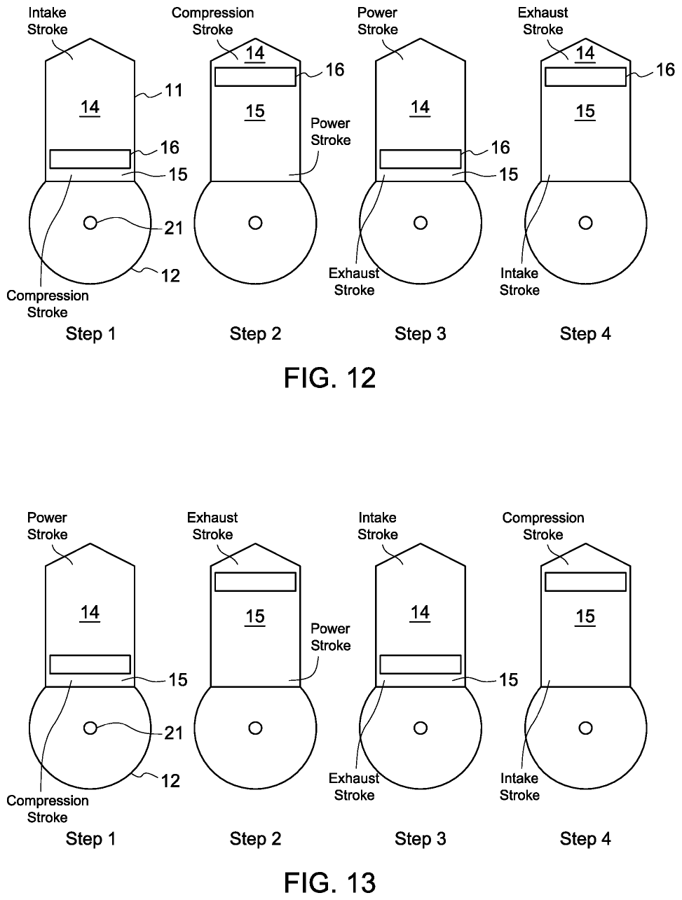

Alternatively, in another example illustrated in FIG. 8, the seal 123 has an inclined inner edge which directs combustion gas or compressed air into the channel 124 to force the seal 123 down and onto the separation plate 18, sealing the lower combustion chamber 15 during compression and combustion strokes. The seal 123 may also be configured to lift off of the separation plate 18 during exhaust and intake strokes to reduce friction. For example, an extension spring 127, as illustrated, or a magnet (not shown) may be provided to lift the seal 123 off of the separation plate 18, or, alternatively, the seal 123 may comprise an inclined outer edge (not shown) so that the seal 123 is lifted by the hydrodynamic effect of the film of oil. It is important the inclined outer edge is configured so that the hydrodynamic effect is easily overcome by the force of combustion gas or compressed air during compression and combustions strokes so that the combustion chamber 15 remains during this time. The intake, compression, combustion and exhaust strokes of the lower combustion chamber 15 are explained in more detail below, with reference to FIGS. 12 and 13.

The illustrated seal of FIG. 8 also comprises a lip 126 which extends about its outer edge and provides a seat for an additional labyrinth seal 123a, although this is merely optional.

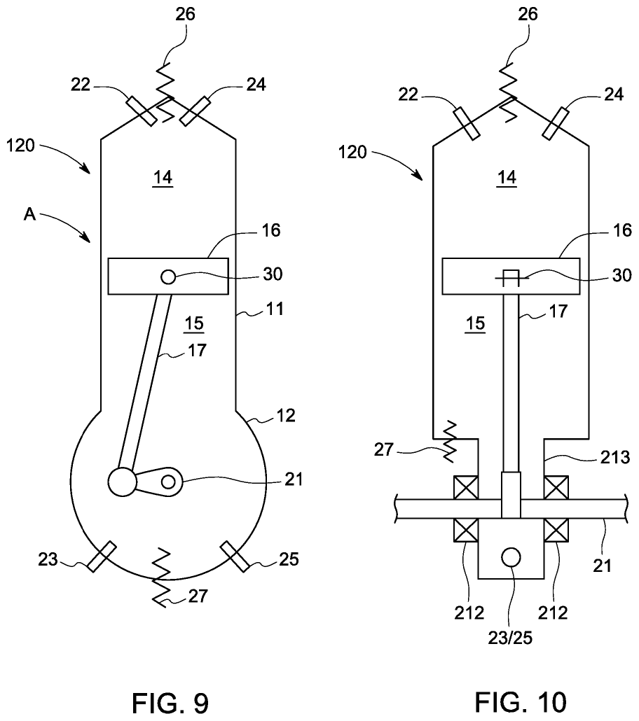

Yet another construction of engine 120 according to the present invention, is shown in FIGS. 9 and 10. This engine is similar to the engine 110 excepting that the lower compression chamber 15 includes a portion of the sump 12 in which valves 23 & 25 and spark plug 27 are located in the wall thereof. Those components present in FIG. 1 will be given the same reference numbers. Each lower chamber 15 extends only into a portion 213 of the sump with the chamber 15 sealed by bearings/seals 212 around the respective portion of the crankshaft 21. In a preferred condition, the total extended volume of the chamber 15 including the respective portion 213 of the sump equates with the effective working volume of chamber 14.

In conventional combustion engines, the cylinder wall and piston are lubricated by the natural dispersion of oil during rotation of the crankshaft, as oil is picked up from the sump and thrown into the cylinder. In more recent engines, oil is sprayed into the cylinder from a nozzle adjacent the connecting rod. In the presently described examples of the engine no, the presence of a lower combustion chamber prevents such forms of lubrication.

Therefore, lubrication for the presently described engines no may include the use of self-lubricating fuels which may comprise added lubricants. Or, alternatively lubrication may be achieved by high pressure lubrication systems pumping lubricant along internal bores in the crankshaft 21 and connecting rods 17 and associated pins and bearings.

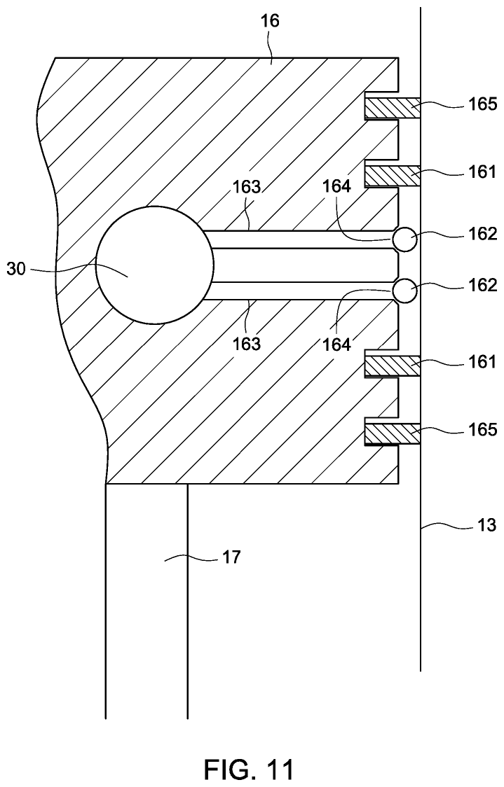

In one example, the lubrication system comprises an oil pump (not shown) which draws oil from the sump 12 and feeds it through a series of oil galleries that channel oil along the crankshaft 21 and up through an oil bore in the connecting rod 17. The oil bore opens onto the pin 30. Further oil galleries provided in the pin 30 transfer oil to piston galleries 163 (see FIG. 11) from where the oil may pass out of openings 164 in the piston cylindrical wall to provide a film of oil on the cylinder wall.

Careful management of this film of lubricant is necessary to prevent excessive oil combustion and to ensure sufficient lubrication of the piston rings 161. The proposed solution may use any combination of the oil distribution control techniques set out below:

Each of the openings 164 on the cylindrical wall of the piston may be provided with a valve 162 configured to regulate the oil film thickness on the cylinder wall. For example, the valve 162 may be configured so that when the hydostatic oil pressure of the film of oil between the cylindrical wall of the piston 16 and the cylinder 13 drops below the oil pressure in the piston galleries 163, the valve 162 opens and oil passes out, replenishing the oil film. In the illustrated example each valve 162 comprises a ball bearing located in a countersunk mouth of the opening 164.

Alternatively, valves are omitted and the oil film thickness is instead regulated simply by careful design of the diameter of each opening 164.

Each piston comprises an upper and lower piston ring 161 with the openings of the oil galleries 163 located between the piston rings 161. Further oil control rings 165 are provided to retain the oil film, as much as possible, between the piston rings 161. The oil control rings 165 are provided outwardly of the piston rings 161, that is to say nearer upper and lower surfaces of the piston 16. The oil control rings 165 scrape excess oil from the cylinder walls to prevent excessive oil remaining in the combustion chamber during combustion.

As a further measure to control the oil film the cylindrical wall of the piston is further provided with oil scavenging ports (not shown), through which excess oil can flow back into the galleries. The oil scavenging ports comprise one way valves, such as calibrated spring loaded stem valves, to ensure oil back into the oil galleries only when the hydrostatic oil pressure exceeds a predetermined value.

The engine may use sleeved cylinders having oil porous walls and oil drainage may be provided for the removal of excess oil.

The use of oil porous metals which are pre-impregnated with oil may be possible for short life engine for example but without limitation, racing engines which are stripped between races.

The oil may also acts as a coolant for the engine.

Using the Otto cycle as an example, the operational cycle of the two chambers 14 and 15 will now be explained. In such an example, each chamber 14, 15 is provided with respective inlet valves 22, 23, exhaust valves 24, 25 and spark plugs 26, 27.

The engine no in this example comprises a single piston 16 to produce a power stroke in both directions of movement of the piston (i. e towards and away from the crankshaft), which will hereinafter be called a double stroke cycle.

One operational cycle of the two chamber 14 & 15 will be explained with reference to FIG. 12:

Step 1: has the lower chamber 15 in the compression stroke with the upper chamber 14 in the induction stroke.

Step 2: has the lower chamber 15 in the power stroke and the upper chamber 14 in the compression stroke.

Step 3: has the lower chamber 15 in the exhaust stroke and the upper chamber 14 in the power stroke, and

Step 4: has the lower chamber 15 in the induction stroke and the upper chamber 14 in the exhaust stroke.

The cycle then begins again at step 1.

In essence at any stage in the cycle, the stroke in the lower chamber 15 is repeated in the upper chamber 14 during the next consecutive stroke.

An alternative operational cycle of the two chambers will be explained with reference to FIG. 13:

Step 1 has the lower chamber 15 in the compression stroke with the upper chamber in the power stroke.

Step 2 has the lower chamber 15 in the power stroke with the upper chamber in the exhaust stroke.

Step 3 has the lower chamber in the exhaust stroke with the upper chamber 14 in the induction stroke.

Step 4 has the lower chamber 15 in the induction stroke with the upper chamber in the compression stroke.

The cycle then begins again at step 1. In essence at any stage in the cycle the stroke in the lower chamber 15 is one step behind the stroke in the upper chamber.

Any number of cylinders can be incorporated in an engine system, each cylinder using one of the operational cycles shown in FIG. 11 or 12, and in some engine systems some cylinders may operate on one cycle while other cylinders operate simultaneously on the other cycle. It shall also be appreciated that the engine can operate on other cycles.

1. A linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a joint disposed in the separation plate, the joint comprising a bore through which a connecting rod extends to connect the piston to a crankshaft, wherein movement of the piston along a longitudinal axis of the cylinder causes the connecting rod to rotate the crankshaft, said rotation of the crankshaft causing both transverse and angular movement of the connecting rod relative to the longitudinal axis of the cylinder, the angular movement of the connecting rod causing a corresponding angular movement of the joint; wherein the separation plate is configured to slide across the lower end of the cylinder to accommodate said transverse movement of the connecting rod; and wherein the joint comprises a curved outer surface configured to ensure contact with an outer seal disposed between the separation plate and the joint during said angular movement of the joint and the connecting rod;
the joint further comprising an inner seal disposed between the bore and the connecting rod;
wherein the outer and inner seals are selected from any of:
a split ring compression seal;
a split ring expansion seal;
a gapless expansion seal;
a gapless compression seal;
a labyrinth seal; and
a brush seal.

2. An engine according to claim 1, wherein the inner seal comprises at least two seals spaced along the bore of the joint.

3. An engine according to claim 1, wherein each inner seal is located in a respective groove in the bore of the joint.

4. An engine according to claim 1, wherein the inner seal is a labyrinth seal comprising a castellated inner edge.

5. An engine according to claim 1, wherein the curved outer surface of the joint is a spherical outer surface.

6. An engine according to claim 1, wherein the lower end of the cylinder is provided with a separation plate seal between the lower combustion chamber and the separation plate.

7. An engine according to claim 1, further comprising a bottom end component housing the crankshaft, the bottom end component being arranged to hold the separation plate against the lower end of the cylinder.

8. An engine according to claim 7, wherein a seal is disposed between the bottom end component and the separation plate.

9. A linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a connecting rod extending through a sealed opening of the separation plate and connecting the piston to a crankshaft;
wherein movement of the piston along a longitudinal axis of the cylinder causes the connecting rod to turn the crankshaft, the separation plate being configured to accommodate movement of the connecting rod in a transverse direction, relative to the longitudinal axis of the cylinder;
and wherein the separation plate is curved to project into the cylinder and distribute combustion forces to edges of the separation plate.

10. A linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a connecting rod extending through a sealed opening of the separation plate and connecting the piston to a crankshaft;
wherein the piston comprises oil outlets disposed in a cylindrical outer face of the cylinder, said oil outlets communicating with an oil gallery extending through the connecting rod; and wherein each oil outlet is configured to regulate the oil film thickness on the cylinder wall.

11. An engine according to claim 10, wherein each oil outlet comprises a valve.

12. An engine according to claim 11, wherein each valve comprises a ball bearing located in a countersunk mouth of a respective oil outlet.

13. An engine according to claim 10, wherein the piston comprises upper and lower oil control rings, the oil outlets being located between the oil control rings.

14. An engine according to claim 13, wherein the piston further comprises oil scavenging ports in the cylindrical wall, the oil scavenging ports being configured to absorb excess oil from the cylinder wall.

15. A linear reciprocating piston engine comprising:
a cylinder;
a piston located within the cylinder, the piston separating upper and lower combustion chambers of the cylinder;
a separation plate disposed across a lower end of the cylinder to seal the lower combustion chamber; and
a connecting rod extending through a sealed opening of the separation plate and connecting the piston to a crankshaft;
wherein the separation plate is located in a guide configured to allow the separation plate to move to accommodate transverse movement of the connecting rod, relative to a longitudinal axis of the cylinder, the guide comprising internal oil galleries configured to provide pressurised oil to support the separation plate on a hydrostatic oil bed.

16. An engine according to claim 15, wherein the lower end of the cylinder is provided with a separation plate seal between the lower combustion chamber and the separation plate.

17. An engine according to claim 16, wherein the separation plate seal is a labyrinth seal.

18. An engine according to claim 17, wherein the separation plate seal is a brush seal.

19. An engine according to claim 15, wherein the separation plate seal comprises an inclined inner edge configured to press the separation plate seal onto the separation plate in response to increasing pressure in the cylinder.

20. An engine according to claim 15, wherein the separation plate seal a lifting mechanism configured to lift the separation plate seal off of the separation plate.

21. An engine according to claim 20, wherein the lifting mechanism comprises one of an extension spring and a magnet.

22. An engine according to claim 20, wherein the lifting mechanism comprises an inclined outer edge of the seal configured to lift the seal off of the separation plate in response to hydrodynamic oil pressure.
